(19) United States
(12) Patent Application Publication
(10) Pub. No.: US 2025/0373421 A1
(43) Pub. Date: Dec. 4, 2025

(54) SERVER DEVICE FOR USING HOMOMORPHIC ENCRYPTED MASTER KEY AND METHODS THEREOF

(71) Applicant: CRYPTO LAB INC., Seoul (KR)

(72) Inventors: Michael Pak, Portland, OR (US); Junbum Shin, Suwon-si (KR); Jung Woo Kim, Seoul (KR); Jung Hee Cheon, Seoul (KR)

(21) Appl. No.: 19/169,947

(22) Filed: Apr. 3, 2025

(30) Foreign Application Priority Data
Apr. 4, 2024 (KR) 10-2024-0046029
Mar. 28, 2025 (KR) 10-2025-0040334

(51) Int. Cl. H04L 9/08; H04L 9/00

(52) U.S. Cl. CPC H04L 9/0869; H04L 9/008; H04L 9/0894

(57) ABSTRACT

A server device is provided. The server device includes an interface configured to communicate with an application device in which an application that uses plaintext data is installed, a memory, and a processor, wherein the processor is configured to generate a homomorphic encrypted master key corresponding to the application device and index information for the master key, store the homomorphic encrypted master key and the index information in the memory, and provide the index information to the application device through the interface. Accordingly, various data processing may be performed, while security is maintained without dedicated hardware.

### BACKGROUND

### Field

The disclosure relates to a server device using a homomorphic encrypted master key and a data processing method thereof.

### Description of the Related Art

As mobile communication technology has developed, services provided using the Internet have increased. For example, there may be various financial services, cloud services, etc.

Security is very important for these services. Accordingly, various systems and technologies have been used to prevent leakage of encryption keys.

One of various systems and technologies may be a hardware security module (HSM). The HSM is a technology that maximizes security by performing encryption operations based on hardware. When a device on which the HSM is installed is physically damaged, The HSM may perform operations, such as deleting internal data, restrict access based on administrator and user roles, or monitoring key usage records, thereby safely storing various keys used for encryption.

In order to maintain security using the HSM, hardware, such as a secure processor and secure storage has to be essentially used. Therefore, there was a problem that hardware installation and maintenance are costly. In addition, there was a problem that high technical knowledge is required to operate the HSM and that expandability is limited.

Therefore, the need for a technology that may replace the HSM has emerged.

### SUMMARY

The disclosure is to provide a server device capable of securely maintaining and using various keys using homomorphic encryption technology and a data processing method thereof.

According to one or more embodiments of the disclosure, a server device includes: an interface connected to an application device in which an application that uses plaintext data is installed; a memory; and a processor, wherein the processor is configured to generates a homomorphic encrypted master key corresponding to the application device and index information for the master key, store the homomorphic encrypted master key and the index information in the memory, and provide the index information to the application device through the interface.

According to one or more embodiments of the disclosure, a data processing method of a server device of processing data of an application device in which an application using plaintext data is installed includes: generating and storing a homomorphically encrypted master key corresponding to the application device and index information for the master key by using an encrypted security module (ESM) that performs an operation in a homomorphic encrypted form and an ESM API for interaction between the application device and the ESM; providing the index information to the application device; and performing, when the index information and a data processing request are received from the application device, data processing according to the data processing request by using the master key corresponding to the index information.

According to various embodiments of the present disclosure, keys required for various encryption operations may be securely generated, stored, and used without implementing a hardware security module. Accordingly, the configuration of a system for processing encryption data may be facilitated, and scalability may also be significantly increased.

### BRIEF DESCRIPTION OF THE DRAWINGS

FIG. 1 is a diagram illustrating a configuration of a data processing system according to at least one embodiment of the disclosure;

FIG. 2 is a block diagram illustrating a configuration of a server device according to at least one embodiment of the disclosure,

FIG. 3 is a diagram illustrating a configuration of a software module used in the server device of FIG. 2;

FIG. 4 is a diagram illustrating a process of generating a homomorphic encrypted master key in a server device according to at least one embodiment of the disclosure;

FIG. 5 is a diagram illustrating a process of generating a homomorphic encryption data key in a server device according to at least one embodiment of the disclosure;

FIGS. 6 to 8 are diagrams illustrating a data processing method according to various embodiments of the disclosure; and

FIG. 9 is a flowchart illustrating a data processing method according to at least one embodiment of the disclosure.

### DETAILED DESCRIPTION

In an information (data) transmission process performed in the disclosure, encryption/decryption may be applied as needed. In the disclosure and claims, expressions describing the information (data) transmission process are to be construed as including the case of performing encryption/decryption, even if not mentioned separately.

Expressions, such as “transmit (transfer) from A to B” or “receive by A from B” in the disclosure include transmission (transfer) or reception of another medium in between, and do not just represent direct transmission (transfer) from A to B or direct reception by A from B.

In the description of the disclosure, the order of each step should be understood to be non-limiting, unless the preceding step must be performed logically and temporally before the following step. In other words, except for the exceptional case above, even if the process described in the following step is performed before the process described in the preceding stage, the nature of the disclosure is not affected and the scope of the right should be defined regardless of the order of the steps. Further, in the specification, “A or B” is defined to mean not only selectively indicating either one of A and B, but also including both A and B.

In the disclosure, the term “including” has a meaning encompassing further including other components in addition to the included elements listed.

In the disclosure, only essential components necessary for the description of the disclosure are described, and components unrelated to the essence of the disclosure are not mentioned. Further, it should not be interpreted as an exclusive meaning that includes only the mentioned components, but should be interpreted as a non-exclusive meaning that may include other components.

In the disclosure, the term “value” is defined as including not only a scalar value but also a vector.

A mathematical computation and calculation of each step of the disclosure to be described later may be implemented by a computer operation by a well-known coding method for carrying out the computation or the calculation, and/or coding designed suitable for the disclosure.

Specific mathematical formulas described below are exemplarily described among various possible alternatives, and the scope of the disclosure should not be construed as being limited to the mathematical formulas mentioned in the disclosure.

For convenience of description, the following notations will be used in the disclosure.

a←D: Select element (a) according to distribution (D)
s1, s2∈R: Each of S₁ and S₂ is an element of a set R.
mod(q): Perform modular computation by an element q
[symbol] : Round up an internal value

Hereinafter, various embodiments of the disclosure will be described in detail with reference to the accompanying drawings.

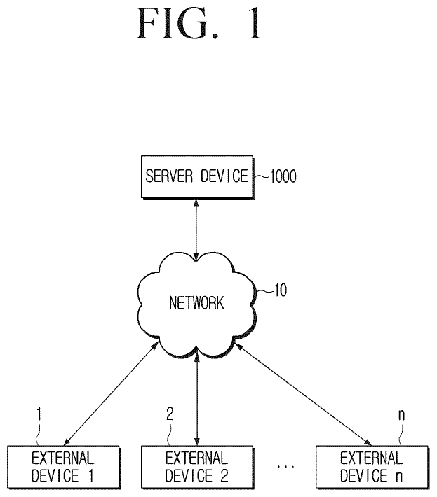

FIG. 1 is a diagram illustrating an operation of a server device according to at least one embodiment of the disclosure. According to FIG. 1, the server device 1000 may perform communication with a plurality of external devices 1 to n through a network 10.

The network 10 may be implemented as various types of wired/wireless communication networks, broadcast communication networks, optical communication networks, cloud networks, etc. In FIG. 1, each of the external devices 1 to n is illustrated as being connected to the server device 1000 through the network 10, but without being limited thereto, and each of the external devices may be connected to the server device 1000 via Wi-Fi, Bluetooth, near field communication (NFC), etc., without a separate medium.

In FIG. 1, the server device 1000 may provide a security service using homomorphic encryption technology to each of the external devices 1 to n. Each of the external devices 1 to n may be various electronic devices, such as mobile phones, tablet PCs, PCs, laptop PCs, server devices, home appliances, kiosks, etc. used by users.

Specifically, the server device 1000 may provide various services requiring security, such as electronic payment services, online banking services, electronic signature and digital authentication services, encrypted email services, key protection and management services of SSL/TLS certificates of websites in HTTPS communication, security services related to blockchains and cryptocurrencies, database encryption services, file and storage encryption services, electronic government and public services, etc., to users of each of the external devices 1 to n through the network 10.

As described above, in the related art, in order to provide such security services, the hardware security module (HSM) using hardware, such as a secure processor and a secure storage, had to be built, but in various embodiments of the disclosure, various keys may be used in an encrypted state by using homomorphic encryption technology, without hardware dedicated to security, thereby providing the various security services described above. Such a security module is referred to as an encrypted security module (ESM) in the disclosure. However, without being limited to this term, and ESM may be replaced with various terms.

In FIG. 1, the server device 1000 is illustrated as if it were one device, but the server device 1000 may be implemented in a form that includes at least one server device or may be implemented as a cloud server.

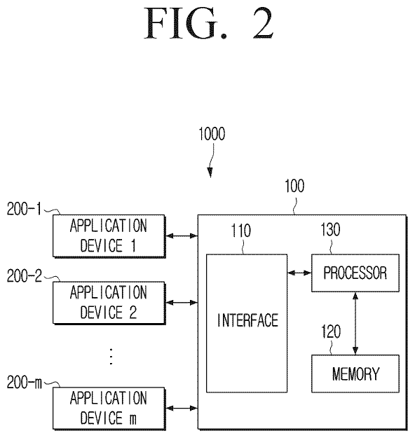

FIG. 2 is a block diagram illustrating a configuration of the server device 1000 according to at least one embodiment of the disclosure.

According to FIG. 2, the server device 1000 may include at least one application device 200-1 to 200-m and a main server 100.

The at least one application device 200-1 to 200-m is an electronic device on which an application corresponding to a service provided by the server device 1000 is installed. This application is an application that uses plaintext data.

The application devices 200-1 to 200-m may also be referred to as front-end servers. The front-end server is a server device for processing data in a plaintext region. The plaintext region refers to a computing environment in which codes, data, etc. basically exist in plaintext. The front-end server operating in the plaintext region may utilize a key management function provided by the ESM equipped in the main server in the same manner as a key management function provided by the existing HSM, secure enclave, trusted platform module (TPM), and other key management systems.

In FIG. 2, a plurality of application devices 200-1 to 200-m are illustrated, but the number of application devices 200-1 to 200-m may vary depending on the type of service provided by the server device 1000, the number of users, etc., and may be implemented as one. The application devices 200-1 to 200-m may be referred to as users or user devices in addition to the front-end server or may be referred to as a first server device for convenience of description.

The main server 100 is a server device that operates in an encrypted region. The encrypted region refers to a computing environment in which codes, data, etc. exist in an encrypted state. The main server 100 may be implemented as a physically independent device from each of the application devices 200-1 to 200-m and may be connected to each other to be used but is not necessarily limited thereto. That is, the application devices 200-1 to 200-m and the main server 100 may be implemented as a single server device with physically separated memory usage regions.

The main server 100 may be described in various ways, such as a security server, an encryption server, a homogeneous encryption server, a key management server, etc. or may be referred to as a second server device for convenience of description.

In FIG. 2, the first server device and the second server device are illustrated separately, but these devices may be implemented as one device or as three or more devices. Accordingly, in various embodiments of the disclosure, the server device 1000 may refer to a device that includes both the application devices 200-1 to 200-m and the main server 100 or may be used to refer only to the main server 100. Hereinafter, the main server 100 will be referred to as a server device 100, and descriptions are given based on a case in which the server device 100 is linked with the plurality of application devices 200-1 to 200-m.

As described above, when the server device 100 uses the ESM, the security of various keys or data may be strengthened without building a hardware security module, so that the installation cost or maintenance cost may be significantly reduced and usability may also be significantly expanded.

The server device 100 includes an interface 110, a memory 120, and a processor 130. The interface 110 is a component connected to an application device in which an application using plaintext data is installed.

The interface 110 may transmit and receive various signals and data to and from an external device through various wired and wireless communication methods, such as a wired/wireless local area network (LAN), a wide area network (WAN), Ethernet, IEEE 1394, Bluetooth, AP-based Wi-Fi (wireless LAN network), Zigbee, high-definition multimedia interface (HDMI), universal serial bus (USB), mobile high-definition link (MHL), audio engineering society/European broadcasting union (AES/EBU), optical, coaxial, etc. The interface 110 may also be described as a communication unit or a communication module.

The memory 120 is configured to store various programs, data, instructions, etc. required for the operation of the server device 100. The memory 120 may be implemented as at least one of various memories, such as dynamic RAM (DRAM), static RAM (SRAM), synchronous dynamic RAM (SDRAM), one time programmable ROM (OTPROM), programmable ROM (PROM), erasable and programmable ROM (EPROM), electrically erasable and programmable ROM (EEPROM), mask ROM, flash ROM, flash memory, hard drive, or solid state drive (SSD).

The memory 120 may store an API for encrypted interaction with an application device and an encrypted security module for generating at least one key used for data processing and managing the generated key in a homomorphic encrypted form. When the application devices 200-1 to 200-m and the main server 100 are integrated to implement as the single server device 1000, the memory 120 may store applications, keys, kernels, OS, firmware, etc. that operate in the plaintext region.

The processor 130 is a component for controlling the overall operation of the server device 100. The processor 130 may perform various operations based on commands, programs, data, etc. stored in the memory 120. Specifically, the processor 130 may process application data using the API and the ESM stored in the memory 120.

The processor 130 may be implemented as a digital signal processor (DSP) that processes digital signals or a microprocessor. However, without being limited thereto, the processor 130 may include one or more of a central processing unit (CPU), a micro-controller unit (MCU), a micro processing unit (MPU), a controller, an application processor (AP), a communication processor (CP), an ARM processor, an artificial intelligence (AI) processor or may be defined by the corresponding terms.

In addition, the processor 130 may be implemented as a system on chip (SoC) with a built-in processing algorithm or a large scale integration (LSI) or may be implemented in the form of a field programmable gate array (FPGA). The processor 130 may perform various functions by executing computer executable instructions stored in the memory 120.

The processor 130 may generate a master key corresponding to an application device in the form of homomorphic ciphertext and store the same in the memory 120. The processor 130 may also generate index information corresponding to the generated master key.

The index information may be identification information that may identify the master key. Alternatively, the index information may be described in various terms, such as key ID, index ID, identifier, etc. The processor 130 provides the index information corresponding to the master key to the application device through the interface 110.

The processor 130 may individually generate the master key and index information for each of the application devices 200-1 to 200-m.

The master key (MK) is a key for encrypting and protecting various keys, such as a key encryption key (KEK) and a data key (DK) within the ESM. The master key may be generated within the ESM and used.

The key encryption key is a key that may be selectively used to protect a data key, and the data key is a key that encrypts actual data. The data key may be encrypted by the key encryption key or the master key and stored. The data key is usually generated and used once or may be changed periodically.

When index information is received from each of the application devices 200-1 to 200-m afterwards, the processor 130 may perform various tasks requested by the application device using the master key corresponding to the index information. Examples of various tasks will be described in detail in the following section.

The processor 130 may process data in a homomorphic encrypted form using a master key in a homomorphic encrypted form and then perform homomorphic decryption for an application device operating in a plaintext region and transmit the data to the application device.

The homomorphic ciphertext may be generated by encrypting a plaintext message using a public key. The homomorphic ciphertext may be generated in a form that satisfies the following property when decrypted using a secret key.

$$Dec ( ct , sk ) = < ct , sk >= M + e ( mod q ) \qquad < Mathematical Formula 1 >$$

Here, <, > means a usual inner product, ct means the ciphertext, sk means the secret key, M means the plaintext message, e means an encryption error value, and mod q means a modulus of the ciphertext. q needs to be selected such that a scaling factor (Δ) is larger than a result value M multiplied by the message. In a case where an absolute value of the error value e is sufficiently smaller than M, a decrypted value M+e of the ciphertext is a value that may replace an original message with the same precision in significant digit computation. In the decrypted data, the error may be positioned on a least significant bit (LSB) side, and M may be positioned on a next least significant bit side.

The public key, the secret key, and the like are required to perform the homomorphic encryption. The processor 130 may generate and use the public key required for performing the encryption on its own, or may receive and use the public key from an external device. For example, another terminal device performing decryption may generate each of the public key and the secret key, and then distribute the public key to other devices.

A method of generating the public key and the private key may be implemented in various ways. For example, the processor 130 may generate the public key by using a Ring-LWE technique. Specifically, the processor 130 may first set various parameters and rings and store the parameters and rings in the memory 120. Examples of the parameters may include a length of plaintext message bits and sizes of the public key and the secret key.

The ring may be expressed by the following mathematical formula.

$$R = {ℤ}_{q} [ x ] / ( f ( x ) ) \qquad < Mathematical Formula 2 >$$

Here, R is the ring, Z_{q} is a coefficient, and f(x) is an n-th polynomial.

The ring means a set of polynomials having preset coefficients, where addition and multiplication are defined between elements, and the set is closed under the addition and the multiplication.

For example, the ring means a set of n-th polynomials whose coefficient is Z_{q}. Specifically, when n is Φ(N), the ring means an N-th cyclotomic polynomial. (f(x)) represents an ideal of Z_{q}[x] generated by f(x). An Euler's totient function Φ(N) means the number of natural numbers that are coprime to N and smaller than N. In a case where Φ_{N}(x) is defined as the N-th cyclotomic polynomial, the ring may also be expressed as the following Mathematical Formula 3.

$$R = {ℤ}_{q} [ x ] / ( {Φ}_{N} ( x ) ) \qquad < Mathematical Formula 2 >$$

The ring of Mathematical Formula 3 described above may have a complex number in a plaintext space. Meanwhile, among the above-described sets of the ring, only a set whose plaintext space is a real number may be used in order to improve a computation speed for the homomorphic ciphertext.

When the ring is set, the processor 130 may calculate the secret key sk from the ring.

The secret key sk may be expressed as follows.

$$sk ← ( 1 , s ( x ) ) , s ( x ) ∈ R \qquad < Mathematical Formula 4 >$$

Here, s(x) means a polynomial randomly generated with a small coefficient.

Further, the processor 130 may calculate a first random polynomial (a (x)) from the ring. The first random polynomial may be expressed as follows.

$$a ( x ) ← R \qquad < Mathematical Formula 5 >$$

In addition, the processor 130 may calculate the error. Specifically, the processor 130 may extract the error from a discrete Gaussian distribution or a distribution that is statistically close to the discrete Gaussian distribution. Such an error may be expressed as follows.

$$e ( x ) ← {𝒟}_{α q}^{n} \qquad < Mathematical Formula 6 >$$

Once the error is calculated, the processor 130 may perform modular computation of the error for the first random polynomial and the secret key to calculate a second random polynomial. The second random polynomial may be expressed as follows.

$$b ( x ) = - a ( x ) s ( x ) + e ( x ) ( mod q ) \qquad < Mathematical Formula 7 >$$

Finally, the public key pk is set as follows in a form including the first random polynomial and the second random polynomial.

$$pk = ( b ( x ) , a ( x ) ) \qquad < Mathematical Formula 8 >$$

The above-described key generation method is only an example, and is not necessarily limited thereto, and it is a matter of course that it is possible to generate the public key and the secret key in other ways

The processor 130 stores the generated public key and secret key in the memory 120. Since these keys are used for homomorphic encryption, they may be collectively referred to as homomorphic encryption keys. In addition to the public key and secret key described above, the homomorphic encryption key may also include an operation key used when performing an operation in a homomorphic ciphertext state. The operation key may include a rotation key, a multiplication key, an addition key, etc. In various embodiments of the disclosure, a CKKS (Cheon-Kim-Kim-Song) scheme, among homomorphic encryption schemes, is used as a basis for a homomorphic encryption scheme, but the homomorphic encryption scheme is not limited thereto, and various schemes, such as the BGV (Brakerski-Gentry-Vaikuntanathan), BFV (Brakerski-Fan-Vercauteren), FHEW (Fully Homomorphic Encryption over the Torus), and TFHE (Torus Fully Homomorphic Encryption) schemes may be used. The processor 130 may process data requested by an application device into a homomorphic ciphertext state and then homomorphically decrypt the result and transmit the same to the application device.

Homomorphic decryption is a task of transforming homomorphic ciphertext into plaintext. Assuming the CKKS method, the processor 130 applies the secret key sk to the homomorphic ciphertext ct=(c0, c1) to generate the message polynomial D(c, sk)=c0+c1·sk and then scales the same by applying the scaling factor Δ to restore the approximate message M′ for the original message M. Thereafter, the processor 130 performs an inverse Fourier transform to restore the original vector message.

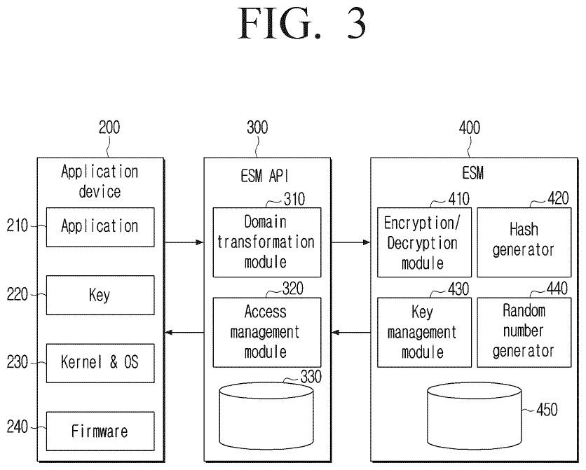

FIG. 3 is a configuration for describing the configuration and operation of various software modules in the server device 1000. For the convenience of description, FIG. 3 illustrates a situation in which an ESM API 300 and an ESM 400 of the main server 100 process data according to a request from an application device 200, and the detailed illustration of other software configurations for interaction between software modules is omitted.

According to FIG. 3, the application device 200 includes a memory in which an application 210, a key 220, a kernel and operating system (OS) 230, firmware 240, etc. are stored.

The application 210 is a software module for configuring a screen for providing a specific service and processing data. The application 210 may provide at least one function using plaintext data. In FIG. 3, one application 210 is illustrated, but a plurality of applications may be installed in one application device 200 and used.

For example, assuming a case of providing an online banking service, a general user may access the server device 1000 using his/her terminal device (i.e., one of the external devices of FIG. 1) and attempt the online banking service. The application device 200 in which the application 210 supporting the online banking service is installed may execute the application 210 according to the operation of the kernel and OS 230, and the firmware 240. The application 210 may provide the online banking service by using the key 220 required for online banking according to data or a request input by the user. While the online banking service is being provided, if a decryption key is required to decrypt encryption data or if decryption data itself for ciphertext is required, the application 210 may request the decryption key or the decryption data from the ESM 400 through the ESM API 300.

The server device 100 may perform various data processing operations according to a request from the application device 200. The server device 100 may use a master key that has been previously generated and stored for data processing.

Specifically, the application device 200 may transmit index information previously provided from the server device 100 to the server device 100. Since the application device 200 operates in a plaintext region, the index information is in a plaintext form. The server device 100 receives signals and data transmitted from the application device 200 through the interface 110. The processor 130 may perform a processing operation requested by the application device 200 using the ESM API 300 and the encrypted security module 400 stored in the memory 120.

The encrypted security module (ESM) 400 is a software module that performs operations in a homomorphic encrypted form, and the ESM API 300 is an interface module for interaction between the encrypted security module 400 and the application device 200. Specifically, the ESM API 300 is a software module for providing an API set that may access the ESM 400 and an access control mechanism therefor.

The ESM API 300 homomorphically encrypts plaintext data transmitted from the application device 200 and transmits homomorphic ciphertext data to the ESM 400, and thereafter, when the ESM 400 performs operations in the homomorphic encrypted form, the ESM 400 homomorphically decrypts the results and transmits the same in the form of plaintext data to the application device 200.

When the ESM 400 receives index information in a homomorphic encrypted form, the ESM 400 may identify a master key corresponding to the index information from the memory 120 and then perform a requested operation using the master key. Specifically, the ESM 400 may provide a decryption key to be used for the corresponding application device 200 or may directly decrypt encryption data, i.e., ciphertext, transmitted from application device 200 using the decryption key and then provide the same.

The ESM API 300 homomorphically decrypts the result data in the form of homomorphic ciphertext processed in the ESM 400 and transmits the same to the application device 200.

For example, the ESM API 300 includes a domain transformation module 310, an access management module 320, and a database 330. The domain transformation module 310 is a module for performing homomorphic encryption and homomorphic decryption. Accordingly, data of the application device 200 that processes data in a plaintext region may be transformed into data in the form of homomorphic ciphertext and transmitted to the ESM 400. In addition, the domain transformation module 310 may also homomorphically decrypt the operation result of the ESM 400 and transmit the same to the plaintext region so that the application device 200 may use it.

The access management module 320 is a software module for performing at least one of authentication to verify the identity of a user accessing the ESM 400, authorization to grant ESM API usage rights according to the user's role, session and access control to manage connection (session) with the ESM 400 and control a session to be allowed only for an authenticated user, auditing and logging to store ESM API call records as logs and manage them, and other policy-based access control operations.

The server device 100 may, in a state in which a session with the application device 200 is connected through the ESM API 300, receive digital signature data or verification data, etc. according to the execution of the access management module 320, authenticate the user, and then determine whether to allow or block access to the server device 100.

The database 330 may store various keys (e.g., a homomorphic encryption key, encryption key, decryption key, etc.) and data required for the operation of the ESM API 300. Specifically, a user account and authentication information (e.g., password hash values, certificates, etc.) that may be used for authentication and access control, ESM API access authority information, policy-based access control data, hash values related to encryption operations, random numbers, certificates, key exchange data, digital signature data, etc. may be stored. In addition, record data, such as ESM API call logs and event logs, and data on key usage policies, security settings, etc. may also be stored.

The ESM 400 is a software module that stores various keys, including the master key, in a homomorphic encrypted form and uses them in a homomorphic encrypted form. The ESM 400 may include an encryption/decryption module 410, a hash processing module 420, a key management module 430, a random number generator 440, a database 450, etc. For convenience of description, the database 330 of the ESM API 300 may be referred to as a first database, and the database 450 of the ESM 400 may be referred to as a second database.

The encryption/decryption module 410 is a component for encrypting or decrypting data using an encryption method requested by the application device 200. For example, encryption and decryption may be performed using a symmetric key encryption technique, such as advanced encryption standard (AES), data encryption standard (DES), etc., or may be performed using an asymmetric key encryption technique, such as Rivest-Shamir-Adleman (RSA), elliptic curve cryptography (ECC), etc.

The hash processing module 420 is configured to perform a hash operation according to various hash algorithms, such as secure hash algorithm (SHA), message digest algorithm 5 (MD5), etc.

The key management module 430 is configured to generate or manage various keys, such as a master key, a data key, an encryption key, and a homomorphic encryption key.

The random number generator 440 is configured to generate random numbers used for various key generation or electronic signatures. The random number generator 440 may be implemented as a true random number generator (TRNG), a pseudo random number generator (PRNG), a cryptographically secure PRNG (CSPRNG), etc.

The second database 450 is configured to store various data used in each component of the encryption security module 400.

The encryption security module 400 may perform processing operations requested by the application device 200 using the various components described above.

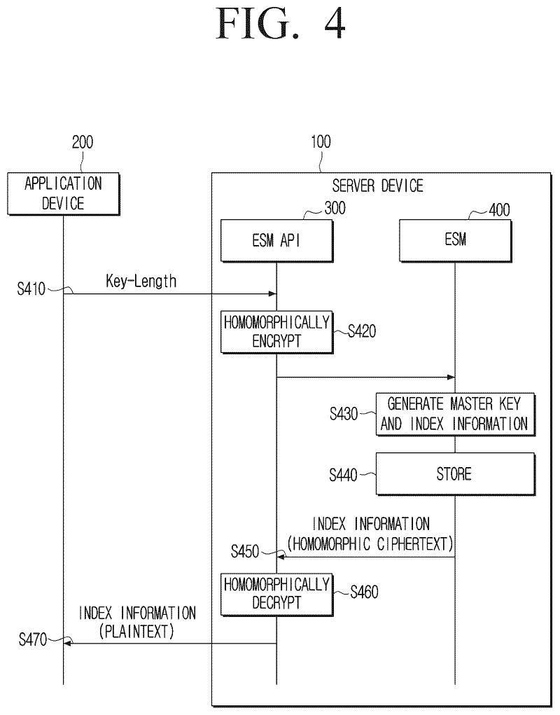

FIGS. 4 to 8 are diagrams illustrating various operations performed by the server device according to at least one embodiment of the disclosure. The processor 130 of the server device 100 may perform the following various processing operations according to the execution of the ESM API 300 and the encryption security module 400 described above with reference to FIG. 3.

First, FIG. 4 illustrates a method of generating and storing a homomorphic encrypted master key.

The processor 130 performs homomorphic encryption on key length information transmitted from the application device 200 using a homomorphic encryption key according to the execution of the ESM API 300 and the encryption security module 400, randomly generates a master key having a length according to the key length information in a homomorphic encrypted form, and generates index information corresponding to the master key.

The processor 130 stores the generated master key and index information in the memory 120, decrypts the index information using the homomorphic encryption key, and transmits the same to the application device 200 through the interface 110.

The application device 200 may provide information to be used for generating the master key (S410). In FIG. 4, the case of providing key length information Key length is illustrated, but various additional information may be provided in addition.

The ESM API 300 homomorphically encrypts the plaintext key length information and provides the same to the ESM 400 (S420).

The ESM 400 randomly generates a homomorphically encrypted master key using the random number generator 440 (S430). The generated master key has a length corresponding to the key length information. The ESM 400 also generates index information corresponding to the homomorphically encrypted master key. The ESM 400 matches the homomorphic encrypted master key to the index information and stores the same in the second database 450 (S440). Since the ESM 400 performs various operations in a homomorphic ciphertext domain, even if the master key or index information of the ESM 400 is described below, it should be understood as the master key in the homomorphic encrypted form or the index information in the homomorphic encrypted form.

The ESM 400 provides the index information in the form of homomorphic ciphertext to the ESM API 300 (S450). The ESM API 300 homomorphically decrypts the index information and transforms the same into plaintext (S460). The ESM API 300 transmits the transformed index information to the application device 200 (S470).

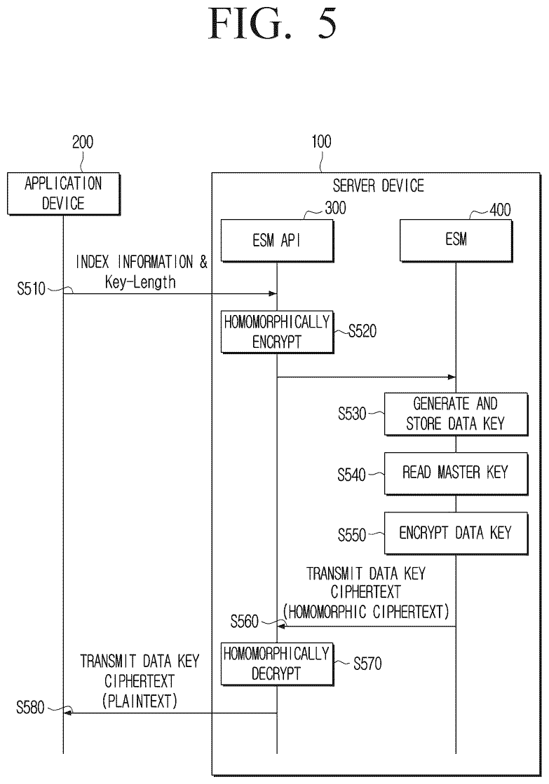

FIG. 5 illustrates a method of generating and storing a homomorphic encryption data key. The length of the data key may also be set to be different depending on the application. The application device 200 transmits data key length information and index information to the server device 100 (S510). Each of the data key length information and the index information is plaintext data.

When the data key length information and the index information are received from the application device 200 through the interface 110, the processor 130 executes the ESM API 300 and the encryption security module 400.

Here, the ESM API 300 homomorphically encrypts each of the data key length information and the index information and then provides them to the ESM 400 (S520). The ESM 400 randomly generates a data key having a length according to the homomorphically encryption data key length information in a homomorphic encrypted form and stores the data key in the memory 120 (S530).

The processor 130 reads a master key corresponding to the homomorphically encrypted index information from the memory 120 (S540). The ESM 400 obtains an operation result that encrypts a homomorphic encryption data key with the read master key (S550). The encryption/decryption module 410 of the ESM 400 may encrypt the data key using one of various encryption techniques, such as AES, DES, RSA, ECC, etc. described above.

The ESM 400 provides the obtained operation result, i.e., the encryption data key data, to the ESM API 300. The ESM API 300 performs homomorphic decryption using a homomorphic encryption key (S570). The ESM API 300 transmits homomorphically decrypted data, i.e., homomorphically decrypted data key ciphertext, to the application device 200 through the interface 110 (S580).

Meanwhile, data keys may be generated in various manners depending on the encryption type. The application device 200 may select a data key type based on the encryption technique to be used.

Specifically, the application device 200 transmits key type information and index information to the server device 100.

When key type information and index information are received from the application device 200 through the interface 110, the processor 130 generates a data key corresponding to the key type information in a homomorphic encrypted form according to the execution of the ESM API 300 and the encryption security module 400. For example, the key type information may be various information, such as AES, DES, 3DES, RC4, RSA (RSA-2048, RSA-4096, etc.), ECC (ECC-P256, ECC-P384, etc.).

The processor 130 stores the generated data key in the memory 120.

The processor 130 reads a master key corresponding to the homomorphically encrypted index information from the memory 120.

The processor 130 homomorphically decrypts an operation result of encrypting the homomorphically encrypted data key with the read master key and then transmits the same to the application device 200 through the interface 110.

Meanwhile, as described above, the homomorphic encryption technique may also be applied in various manners. The application device 200 may select not only the type of the data key but also the homomorphic encryption type.

When the homomorphic encryption type information and the index information are received from the application device 200 through the interface 110, the processor 130 generates each of a homomorphic encryption public key, a homomorphic encryption secret key, an operation key, and an homomorphic encryption key ID corresponding to the homomorphic encryption type information in a homomorphic encrypted form and stores them in the memory 120.

The processor 130 reads the master key corresponding to the homomorphic encrypted index information from the memory 120 and obtains an operation result that encrypts the generated homomorphic encrypted secret key using the read master key.

The processor 130 homomorphically decrypts the obtained operation result and the generated homomorphic encrypted secret key, operation key, and homomorphic encrypted key ID and then transmits them to the application device 200 through the interface 110.

Alternatively, when the homomorphic encryption type information is received from the application device 200 through the interface 110, the processor 130 may generate a homomorphic encryption public key, a homomorphic encryption secret key, and an operation key, and a homomorphic encryption key ID corresponding to the homomorphic encryption type information in a homomorphic encrypted form, store them in the memory 120, homomorphically decrypt the homomorphic encryption public key, the operation key, and the homomorphic encryption key ID, and then transmit them to the application device 200.

Meanwhile, the application device 200 may store the data key ciphertext and request the server device 100 to decrypt the data key as needed.

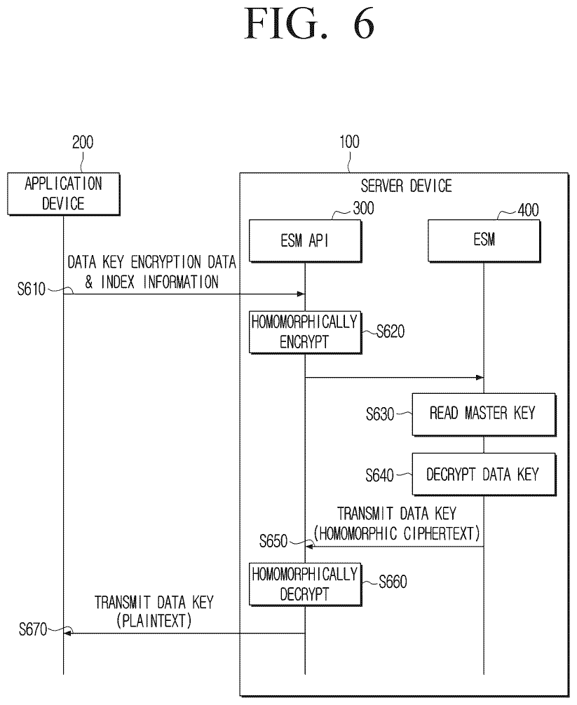

FIG. 6 is a diagram illustrating a method of performing decryption on a data key in a server device according to at least one embodiment of the disclosure.

The processor 130 receives encryption data and index information for the data key from the application device 200 through the interface 110. The encryption data for the data key is data encrypted using one of the various encryption techniques described above and may alternatively be described as data key ciphertext or data key encryption data.

The ESM API 300 homomorphically encrypts the received data key encryption data and index information and provides them to the ESM 400 (S620).

The ESM 400 reads a master key corresponding to the homomorphically encrypted index information from the memory 120 (S630). The ESM 400 decrypts the homomorphically encryption data key encryption data using the read master key to obtain a data key (S640). The obtained data key is in the form of homomorphic ciphertext.

The ESM 400 provides the obtained data key to the ESM API 300, and the ESM API 300 homomorphically decrypts the data key in the form of homomorphic ciphertext (S660) and then provides the homomorphically decrypted data key to the application device 200 (S670).

The application device 200 may request the server device 100 to decrypt not only the encryption data for the data key, but also the encryption data for the homomorphic encryption secret key.

When the encryption data and index information for the homomorphic encryption secret key are received from the application device 200 through the interface 110, the processor 130 provides the homomorphic encryption secret key according to the execution of the ESM API 300 and the encryption security module 400.

Specifically, the processor 130 homomorphically encrypts each of the encryption data and index information for the received homomorphic encryption secret key and reads the master key corresponding to the homomorphically encrypted index information from the memory 120.

The processor 130 decrypts the homomorphically encrypted encryption data with the master key to obtain the homomorphic encryption secret key. The processor 130 homomorphically decrypts the homomorphic encryption secret key in a plaintext form and then transmits the homomorphic encryption secret key in the plaintext form to the application device 200 through the interface 110.

Meanwhile, the application device 200 may request encryption of the data while transmitting the data to the server device 100.

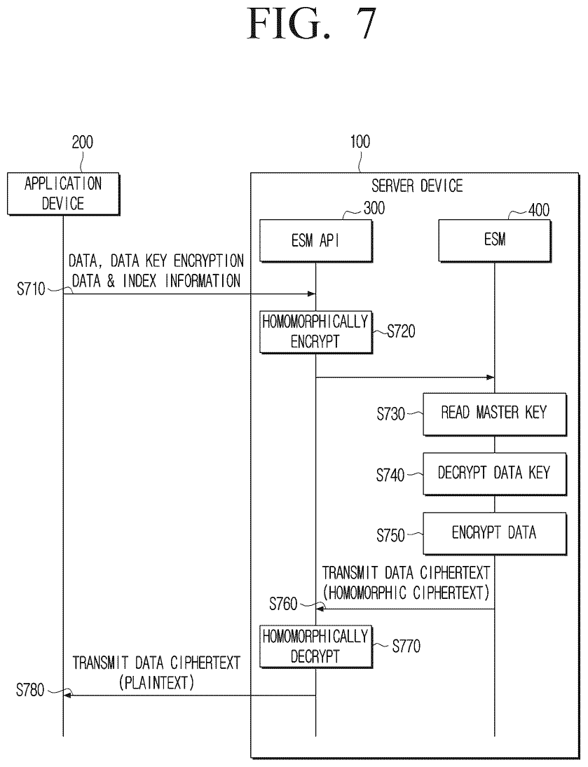

FIG. 7 is a diagram illustrating a method of encrypting data.

According to FIG. 7, the application device 200 transmits data, data key encryption data, and index information to the server device 100 (S710).

The ESM API 300 of the server device 100 homomorphically encrypts the received data, data key encryption data, and index information and transmits them to the ESM 400 (S720).

The ESM 400 reads the master key corresponding to the homomorphically encrypted index information from the memory 120 (S730) and decrypts the data key encryption data using the master key to obtain a data key (S740).

The ESM 400 encrypts homomorphic encryption data using the obtained data key (S750) and provides the same to the ESM API 300 (S760). An encryption result for the data is in the form of homomorphic ciphertext.

The ESM API 300 homomorphically decrypts the provided encryption result (S770) and transmits the same to the application device 100 through the interface 110 (S780).

The application device 200 may provide the encryption data itself to the server device 100 to request decryption of the encryption data.

Specifically, the application device 200 may transmit an encryption key ID and encryption data to the server device 100.

When the encryption key ID and encryption data are received through the interface 110, the processor 130 homomorphically encrypts the encryption key ID and encryption data according to the execution of the ESM API 300 and the encryption security module 400. The encryption key ID is index information for specifying an encryption key used for data encryption other than homomorphic encryption. The encryption key is a key for performing encryption and decryption according to one of the various encryption techniques described above. In the case of a public key encryption technique, the encryption key may include an encryption public key and an encryption secret key.

The ESM 400 reads an encryption secret key corresponding to the homomorphically encrypted encryption key ID from the memory 120. The ESM 400 may decrypt the encryption data using the encryption secret key in a homomorphic encrypted form to obtain data. The decrypted data is in the form of homomorphic ciphertext. The ESM 400 provides the decrypted data to the ESM API 300. The ESM API 300 homomorphically decrypts the provided data and then transmits the same to the application device 200 through the interface 110.

The application device 200 may also request the server device 100 to encrypt data. The application device 200 transmits the encryption key ID and data to the server device 100.

The processor 130 homomorphically encrypts each of the encryption key ID and data according to the execution of the ESM API 300 and the encryption security module 400, reads an encryption secret key corresponding to the homomorphically encrypted encryption key ID from the memory 120, and encrypts the homomorphically encryption data using the encryption secret key.

The processor 130 homomorphically decrypts the encrypted data using the ESM API 300 and transmits the same to the application device 200 through the interface 110.

The server device 100 may also provide an electronic signature using the homomorphically encrypted key.

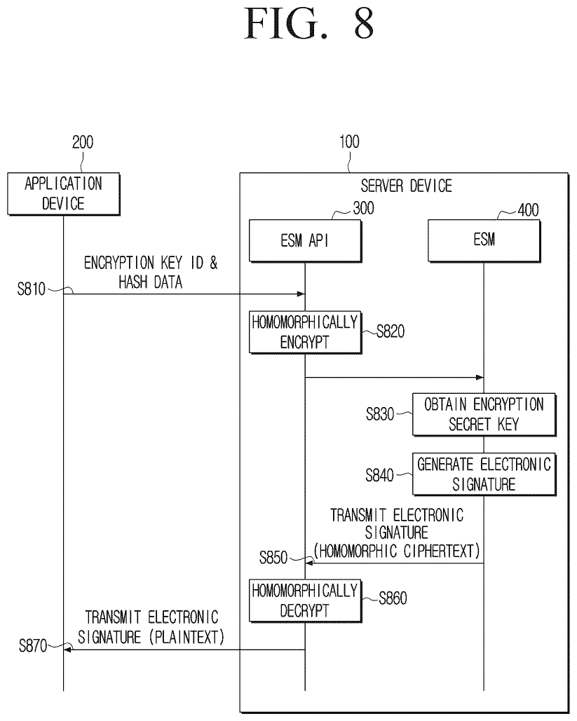

FIG. 8 is a diagram illustrating a method of providing an electronic signature.

According to FIG. 8, the application device 200 may provide an encryption key ID and hash data to the server device 100 (S810).

The ESM API 300 homomorphically encrypts each of the encryption key ID and hash data and transmits them to the ESM 400 (S820).

The ESM 400 reads and obtains an encryption secret key corresponding to the homomorphically encrypted encryption key ID from the memory 120 (S830).

The ESM 400 operates the homomorphically encrypted hash data and the encryption secret key to generate an electronic signature (S840) and then provides the same to the ESM API 300 (S850).

The ESM API 400 homomorphically decrypts the electronic signature in the form of homomorphic ciphertext (S860) and then transmits the same to the application device 200 through the interface 110 (S870).

As described above, the server device 100 may perform various data processing operations using a homomorphic encrypted master key, a homomorphic encryption data key, a homomorphic encrypted encryption key, etc.

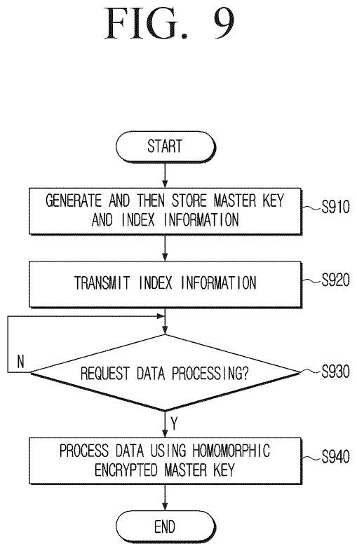

FIG. 9 is a flowchart illustrating a data processing method of a server device according to at least one embodiment of the disclosure.

The server device 100 according to FIG. 9 may store an encrypted security module (ESM) that performs operations in a homomorphic encrypted form and an ESM API for interaction between an application device and the ESM.

The server device 100 generates and stores a homomorphic encrypted master key corresponding to the application device and index information for the master key (S910).

The server device 100 transmits the generated index information to the application device 200 (S920).

The application device 200 may request a necessary processing operation from the server device 100 (S930). The server device 100 performs the requested data processing operation using the homomorphic encrypted master key (S940). An specific processing operation may be performed in various forms as described above with reference to FIGS. 5 to 8.

The operation of generating and storing the homomorphic encrypted master key and index information for the master key includes an operation of homomorphically encrypting key length information transmitted from the application device using the homomorphic encryption key in the ESM API and an operation of randomly generating a master key having a length according to the key length information in a homomorphic encrypted form in the encryption security module, generating index information corresponding to the master key, and storing them separately, and the operation of providing the index information to the application device may include an operation of homomorphically decrypting the index information using the homomorphic encryption key in the ESM API and providing the same to the application device.

According to various embodiments of the disclosure as described above, even without using a hardware security module, various data processing operations required by an application may be performed by securely generating, managing, and using various keys.

In the above-described section, various embodiments have been individually described, but each embodiment does not necessarily have to be implemented alone and may be combined with at least one of other embodiments partially or entirely to be implemented.

In addition, a program for performing various data processing methods described above may be distributed or used in a state of being stored in a non-transitory readable recording medium. A non-transitory readable medium is not a medium for storing data for a short time, such as a register, cache or memory, but refers to a medium that semi-permanently stores data and may be read by a device. Specifically, the non-transitory readable medium may include a CD, DVD, hard disk, Blu-ray disc, USB, memory card, or ROM.

In the above, preferred embodiments have been illustrated and described, but the disclosure is not limited to the specific embodiments described above, and those of ordinary skill in the art pertaining to the disclosure without departing from the gist of the claims. Various modifications are possible by the disclosure, of course, and these modifications should not be individually understood from the technical spirit or perspective of the disclosure.

What is claimed is:

1. A server device comprising:
an interface configured to communicate with an application device in which an application that uses plaintext data is installed;
a memory; and
a processor,
wherein the processor is configured to generate a homomorphic encrypted master key corresponding to the application device and index information for the master key, store the homomorphic encrypted master key and the index information in the memory, and provide the index information to the application device through the interface.

2. The server device of claim 1, wherein
the memory is configured to store an encrypted security module (ESM) that performs operations in a homomorphic encrypted form and an ESM API for interaction between the application device and the ESM, and
the processor is configured to,
set a homomorphic encryption key for the application device and store the homomorphic encryption key in the memory, and
the ESM API is configured to homomorphically encrypt data received from the application device using the homomorphic encryption key and provide the homomorphically encrypted data to the ESM, and decrypt data provided in a homomorphic encrypted form from the ESM using the homomorphic encryption key.

3. The server device of claim 2, wherein, according to an execution of the ESM API and the ESM,
in response to execution of the ESM API and the ESM, the processor is configured to homomorphically encrypt key length information transmitted from the application device using the homomorphic encryption key, randomly generate a master key in a homomorphic encrypted form with a length corresponding to the key length information, generate the index information corresponding to the master key, store the master key and the index information in the memory, homomorphically decrypt the index information using the homomorphic encryption key, and transmit the decrypted index information to the application device through the interface.

4. The server device of claim 3, wherein
the processor is configured to,
when the data key length information and the index information are received from the application device through the interface,
in response to execution of the ESM API and the ESM,
homomorphically encrypt the data key length information, randomly generate a data key having the length corresponding to the data key length information in a homomorphic encrypted form and store the data key in the memory, read the master key corresponding to the index information from the memory, homomorphically decrypt an operation result of encrypting the homomorphically encryption data key with the read master key, and then transmit the homomorphically decrypted operation result to the application device through the interface.

5. The server device of claim 3, wherein
the processor is configured to,
when key type information and the index information are received from the application device through the interface,
in response to execution of the ESM API and the ESM generate a data key corresponding to the key type information in a homomorphic encrypted form and store the data key in the memory,
read the master key corresponding to the index information from the memory,
homomorphically decrypt an operation result of encrypting the homomorphically encryption data key with the read master key, and then transmit the homomorphically decrypted operation result to the application device through the interface.

6. The server device of claim 3, wherein
the processor is configured to,
when homomorphic encryption type information and the index information are received from the application device through the interface,
in response to execution of the ESM API and the ESM, generate each of a homomorphic encryption public key, a homomorphic encryption secret key, an operation key, and a homomorphic encryption key ID corresponding to the homomorphic encryption type information in a homomorphic encrypted form and store the same in the memory,
read the master key corresponding to the index information from the memory, and
homomorphically decrypt an operation result of encrypting the generated homomorphic encryption secret key with the read master key, the generated homomorphic encryption secret key, the operation key, and the homomorphic encryption key ID, and then
transmit the same to the application device through the interface.

7. The server device of claim 3, wherein
the processor is configured to,
when homomorphic encryption type information is received from the application device through the interface,
in response to execution of the ESM API and the ESM, generate each of a homomorphic encryption public key, a homomorphic encryption secret key, an operation key, and a homomorphic encryption key ID corresponding to the homomorphic encryption type information in a homomorphic encrypted form, store the same in the memory,
homomorphically decrypt the homomorphic encryption public key, the operation key, and the homomorphic encryption key ID, and then
transmit them to the application device through the interface.

8. The server device of claim 3, wherein
the processor is configured to,
when encryption data and the index information for the data key are received from the application device through the interface,
in response to execution of the ESM API and the ESM,
homomorphically encrypt the encryption data and the index information for the data key,
read the master key corresponding to the homomorphically encrypted index information from the memory,
decrypt the homomorphically encrypted encryption data with the master key to obtain the data key, homomorphically decrypt the data key in a plaintext form, and then transmit the data key in the plaintext form to the application device through the interface.

9. The server device of claim 3, wherein
the processor is configured to,
when encryption data for homomorphic encryption secret key and the index information are received from the application device through the interface,
in response to execution of the ESM API and the ESM, homomorphically encrypt the encryption data for the homomorphic encryption secret key and the index information,
read the master key corresponding to the homomorphically encrypted index information from the memory,
decrypt the homomorphically encrypted encryption data with the master key to obtain the homomorphic encryption secret key,
homomorphically decrypt the homomorphic encryption secret key to obtain it in a plaintext form, and then transmit the homomorphic encryption secret key in the plaintext form to the application device through the interface.

10. The server device of claim 3, wherein
the processor is configured to,
when data, encryption data for a data key, and the index information are received from the application device through the interface,
in response to execution of the ESM API and the ESM, homomorphically encrypt the data, the encryption data for the data key, and the index information,
read the master key corresponding to the homomorphically encrypted index information from the memory,
decrypt the homomorphically encrypted encryption data using the master key to obtain the data key,
homomorphically decrypt an encryption result of encrypting the homomorphically encryption data using the obtained data key, and then
transmit the same to the application device through the interface.

11. The server device of claim 3, wherein
the processor is configured to,
when an encryption key ID and encryption data are received from the application device through the interface,
in response to execution of the ESM API and the ESM, homomorphically encrypt each of the encryption key ID and the encryption data,
read an encryption secret key corresponding to the homomorphically encrypted encryption key ID from the memory,
decrypt the encryption data using the encryption secret key in a homomorphic encrypted form,
homomorphically decrypt the decrypted data, and then transmit the decrypted data to the application device through the interface.

12. The server device of claim 3, wherein
the processor is configured to,
when an encryption key ID and hash data are received from the application device through the interface,
in response to execution of the ESM API and the ESM, homomorphically encrypt the encryption key ID and the hash data,
read an encryption secret key corresponding to the homomorphically encrypted encryption key ID from the memory,
operate the homomorphically encrypted hash data and the encryption secret key to generate an electronic signature,
homomorphically decrypt the electronic signature, and then transmit the electronic signature to the application device through the interface.

13. The server device of claim 3, wherein
the processor is configured to,
when an encryption key ID and data are received from the application device through the interface,
in response to execution of the ESM API and the ESM, homomorphically encrypt each of the encryption key ID and the data,
read an encryption secret key corresponding to the homomorphically encrypted encryption key ID from the memory,
encrypt the homomorphically encryption data using the encryption secret key,
homomorphically decrypt the encryption data, and then transmit the homomorphically decrypted data to the application device through the interface.

14. A data processing method of a server device of processing data of an application device in which an application using plaintext data is installed, the data processing method comprising:
generating and storing a homomorphically encrypted master key corresponding to the application device and index information for the master key by using an encrypted security module (ESM) that performs an operation in a homomorphic encrypted form and an ESM API for interaction between the application device and the ESM;
providing the index information to the application device; and
performing, when the index information and a data processing request are received from the application device, data processing according to the data processing request by using the master key corresponding to the index information.

15. The data processing method of claim 14, wherein
the generating and storing of the homomorphic encrypted master key and the index information for the master key comprises:
homomorphically encrypting key length information transmitted from the application device using a homomorphic encryption key in the ESM API; and
in the ESM, randomly generating a master key in a homomorphic encrypted form with a length corresponding to the key length information, generating the index information corresponding to the master key, and storing them separately, and
the providing of the index information to the application device comprises:
homomorphically decrypting the index information using the homomorphic encryption key in the ESM API and providing the same to the application device.
